(19) United States
(12) Patent Application Publication
(10) Pub. No.: US 2017/0134499 A1
(43) Pub. Date: May 11, 2017

(54) Synchronization of Wirelessly Distributed Audio and Video for In-Flight Entertainment

(71) Applicant: Systems and Software Enterprises, LLC, Brea, CA (US)

(72) Inventors: Eric P. Moyer, Huntington Beach, CA (US); Victor Ariño Perez, Munich (DE)

(21) Appl. No.: 15/343,703

(22) Filed: Nov. 4, 2016

Related U.S. Application Data
(60) Provisional application No. 62/252,333, filed on Nov. 6, 2015.

(51) Int. Cl. H04L 29/08; H04W 48/10; H04L 29/06; H04W 4/00

(52) U.S. Cl. CPC H04L 67/12; H04W 4/003; H04W 48/10; H04L 65/4084; H04W 4/008; H04W 84/12

(57) ABSTRACT

Systems and methods for delivering synchronized content to in-flight entertainments systems are provided. A content source can transmit a common clock reference to a personal entertainment device (PED) and to a display unit (DU), which indicates a current time of a master clock. A command can be received to initiate playback of a digital content item, and a command message generated that includes a content identifier associated with the digital content item, a playback state of the digital content item and a presentation start time of the digital content item. The command message is transmitted to the PED to initiate playback of a buffered portion of the audio component at the presentation start time, and to the DU to initiate playback of locally stored video content.

This application claims priority to U.S. provisional application having Ser. No. 62/252,333, filed Nov. 6, 2015. This and all other extrinsic materials identified herein are incorporated by reference in their entirety to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is in-flight entertainment systems.

### BACKGROUND

The background description includes information that may be useful in understanding the present invention. It is not an admission that any of the information provided herein is prior art or relevant to the presently claimed invention, or that any publication specifically or implicitly referenced is prior art.

Modern in-flight entertainment options have evolved from the single-content presentation over old CRT monitors. Presently, airlines have updated to in-seat flat panel displays, often allowing passengers to select the content they wish to view. However, the audio presentation remains anchored to the audio headset jacks in armrests, subject to wear and tear and malfunction.

The advent of in-flight wireless networks, in turn, has allowed passengers to use their own portable computing devices for entertainment by streaming of films and television shows over the aircraft's installed wireless network. Additionally, it has allowed for the replacement of the traditional wired in-flight entertainment systems with wireless versions, thus reducing the weight of the system as a whole and facilitating the repair, replacement and updating of various components. However, available wireless bandwidth on in-flight wireless systems is limited and the combined effect of dozens or even hundreds of devices all streaming at once can render the service unusable.

Thus, there is still a need for an in-flight entertainment system that can provide a satisfying in-flight entertainment experience while economizing the use of the limited bandwidth typically available on aircraft.

### SUMMARY OF THE INVENTION

The present invention provides apparatus, systems, and methods in which an in-flight entertainment system for the delivery of synchronized content is provided. Although the term “in-flight entertainment” is used, the system could readily be used in busses, boats, and other vehicles.

Contemplated systems include a content source having a processor, a memory, a wireless communication interface, and a display. The content source can be programmed to transmit a common clock reference to a personal entertainment device (PED) and to a display unit (DU). The common clock reference is an indication of a current time of a master clock. A command can be received by the content source to initiate playback of a digital content item, which includes a video component and an audio component. A command message can be generated by the content source that includes a content identifier associated with the digital content item, a playback state of the digital content item and a presentation start time of the digital content item.

The command message can be transmitted via the wireless communication interface, for example, to the PED. The message causes the PED to initiate playback of a buffered portion of the audio component at the presentation start time. A second or the same command message can be sent to the DU via the wireless communication interface, for example, to thereby cause the DU to initiate playback of locally stored video content. The audio component can be streamed to the PED via the wireless communication interface.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 provides an overview of an illustrative example of the system of the inventive subject matter.

FIG. 2 provides a flowchart of the execution of various functions and processes of the inventive subject matter.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including reducing network congestion in limited-bandwidth environments and ensuring synchronicity in the presentation of audio-visual content via multiple channels.

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some use cases it is necessary to synchronize the playback of video from wirelessly attached network devices with the simultaneous playback of accompanying audio on other wirelessly attached network devices. Because the available wireless bandwidth is limited, it is desirable to distribute video content to aircraft installed video devices prior to presentation. Similarly, for aircraft installed audio devices it is also desirable to distribute audio content prior to presentation. However, for a multitude of reasons (content provider contractual obligations, time constraints, storage space constraints, etc.) it is generally necessary to stream audio to PEDs rather than distributing it in its entirety before presentation.

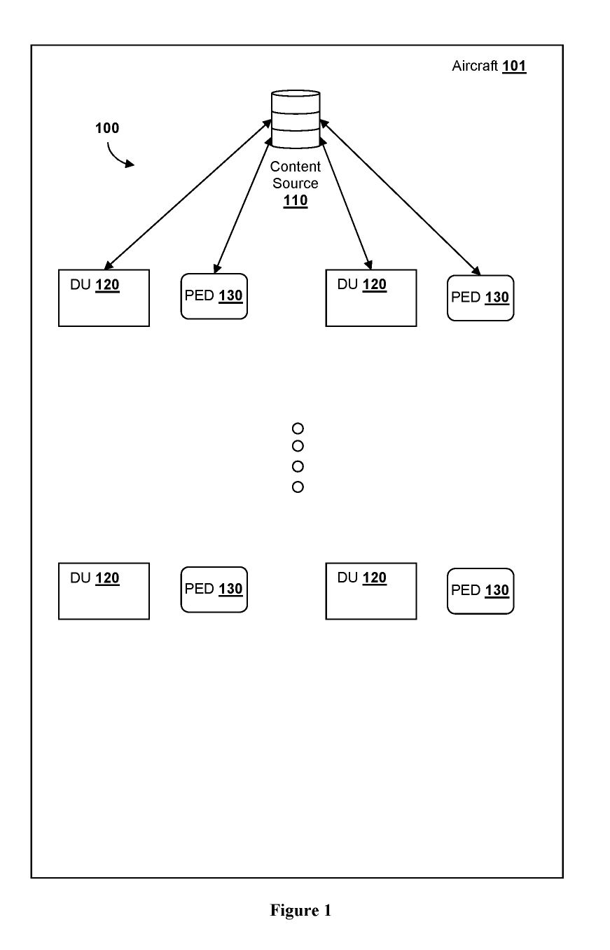

FIG. 1 illustrates an embodiment of the inventive subject matter within aircraft 101. As seen in FIG. 1, system 100 includes a content source 110, an in-flight entertainment unit 120 (also referred to herein as a “Display Unit” or “DU” 120), and a personal electronic device (“PED”) 130. As shown in FIG. 1, it is contemplated that a single vehicle, such as a passenger aircraft 101, can include more than one display unit 120 and more than one personal electronic device 130 within system 100. It should be noted that the description of the inventive subject matter contained herein references an aircraft 101. However, it is contemplated that the system 100 can be applied to other vehicles such as train cars, busses, or other multi-passenger vehicles or enclosed environments where wireless bandwidth is similarly limited.

Content source 110 stores digital content items (e.g., video clips, television shows, films video games) to be distributed to the DUs 120 within an aircraft for playback. In embodiments such as the example illustrated in FIG. 1, content source 110 can be one or more content servers within the aircraft. In these embodiments, the content source 110 can connect to an external source via a wireless or wired connection (such as when the aircraft is on the ground between flights or for routine maintenance) to receive new content items and other updates.

In other embodiments, content source 110 can be a content server external to the aircraft that can connect to the aircraft via a wired or wireless connection (such as when the aircraft is on the ground at a gate). In some variations of these embodiments, the external content source 110 can connect to intermediate networking devices within the aircraft 101, which then wirelessly route the content items to the DUs 120. In other variations, the external content source 110 can transmit the content items directly to the DUs 120 within aircraft 101 via a wireless connection.

The digital content items include a video component to be presented via a display monitor and an audio component (such as an audio track) to be presented via an audio output device.

The system 100 also includes a master clock that is used as a reference clock by all of the DUs 120 and PEDs 130 as will be discussed in further detail below. In embodiments, the master clock can be a clock used by other systems of the aircraft 101 (e.g., such as for radio communications, navigation functions, etc.) made accessible by the various components of system 100 for the purposes and functions of the inventive subject matter. In embodiments, the master clock can be housed and executed by the content source 110 (if internal to the aircraft) and/or by one or more of the DUs 120s (and accessible to all other DUs 120). The common clock reference (i.e., a reference point of the master clock used by receiving devices for synchronization) can be distributed to all of the DUs 120 and to PEDs 130 via a low-bandwidth protocol such as the Precision Time Protocol (“PTP”), ensuring that the clocks are synchronized within a small margin of variance (typically less than one millisecond).

Using a master clock to synchronize all DUs 120 and their corresponding PEDs 130 is beneficial in situations where an item of digital content is to be played back simultaneously, such as in situations where the DUs 120 are shared among multiple passengers (and as such, multiple PEDs 130), such as where DUs 120 are overhead in-flight entertainment units (and thus, a passenger can look at the screen of more than one DU 120 and the video and audio remains synchronized) or where content items are to be played back on a schedule for all DUs 120 rather than on-demand to each passenger.

In embodiments where each passenger has an individual DU 120 with on-demand programming available (and thus, where synchronization with other DUs is not needed), each DU 120 can have an independent playback clock solely for synchronization with a corresponding PED 130. In these embodiments, system 100 can include the independent playback clock in addition to the “global” master clock used to synch all DUs. In alternative embodiments, the system 100 can include only the playback clock in each DU 120, without having the system-wide master clock.

The DU 120 can comprise a memory, a processor, a wireless interface (e.g., Wifi, cellular, etc.), and display screen for video playback. In embodiments, the DU 120 can include a user interface configured to receive user input. The user interface can include a keypad, remote control, touch screen, or other suitable user interface that allows for the user to interact with the DU 120 to access its various functions. Contemplated DUs 120 can include entertainment units integrated into aircraft seats, such as in the seat-backs (this includes both self-contained seatback DUs having all of the components within the seatback unit and also modular DU systems where the display screen is integrated into the seatback but other components such as the storage, communication interfaces and/or processor(s) are located under the seat or in a separate part of the seat), and overhead entertainment units. In the illustrative example of FIG. 1, the DUs 120 are considered to be entertainment units integrated into the seatback. In embodiments, the DU 120 can also include a short-rage wireless data communication interface capable of short-range data exchanges. Examples of short-range wireless interfaces include near-field communication interfaces, Bluetooth, and IR (infra-red). In embodiments, the DU 120 can include a wired connection interface (e.g., USB, HDMI, Thunderbolt, etc.) that can be connected to other computing devices for data exchange and/or power supply.

The personal electronic device 130 can be a computing device capable of data exchange with the DU 120 via wireless networking interfaces (e.g., Wifi, cellular, Bluetooth, NFC, IR, etc.), having a processor and memory capable of buffering and processing audio data for output, and having the capacity to output audio via speakers, headphones, or any other audio output device. In embodiments, the personal electronic device 130 can be a portable computing device carried on board by a passenger or one distributed by flight crews. Contemplated personal electronic devices 130 can include smart phones, tablets, phablets, portable music players (e.g. MP3 players, iPods, etc.), laptop computing devices, netbooks, portable video game consoles, portable media players (video players, DVD players, CD players, etc), smart watches, wearable computing devices, or any other suitable computing device.

The PED 130 can include computer-executable instructions that cause the processor(s) and other components of the PED 130 to execute various functions and processes of the inventive subject matter as described herein. The computer-executable instructions can be in the form of an application that can be downloaded, stored and executed on the PED 130. This application can be made available for download ahead of time via an online app store, or can optionally be downloaded from the DU 120 and/or the content source 110 via wired or wireless connection as made available by the particular embodiments of each of the components of the system 100.

In embodiments where the DU 120 and PED 130 both contain short-range wireless interfaces, the wireless communication between the DU 120 and PED 130 can be limited to using those short-range interfaces, thus reducing the chance of interfering with (and being interfered by) wide-area wireless communications within the aircraft and/or the wireless communications between other DUs 120 and PEDs 130.

In embodiments, the personal electronic device 130 can be a computing device installed into a seat armrest or other part of the seat, such that the personal electronic device 130 is not moved or removed by passengers. In these embodiments, the personal electronic device 130 can be configured to output audio to existing headset jacks in seat armrests, replacing existing wired audio setups.

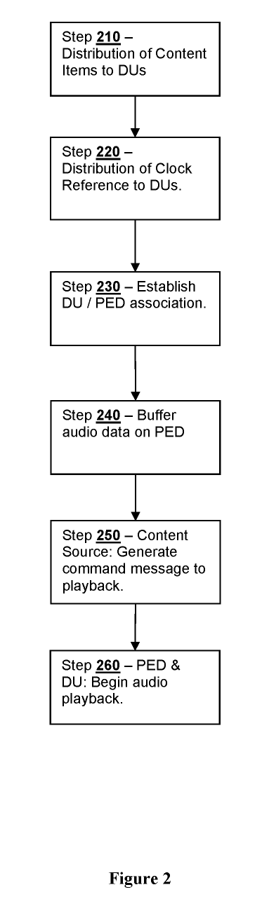

FIG. 2 outlines an illustrative example of the execution of various aspects of the inventive subject matter.

Within the environment of an aircraft in flight, the available bandwidth for wireless communications can be very limited. Thus, the digital content items are distributed in advance from the content source 110 to the DUs 120 at step 210, such that the DUs 120 are preloaded with the digital content items planned for presentation during a flight. To do so, the content source 110 can be programmed to push the content to the DUs 120. Alternatively, the DUs 120 can be programmed to request new content from the content source 110. The distribution can be prior to each flight (e.g., when the aircraft is parked at a gate between flights), during times of low-bandwidth usage, and/or according to a periodic schedule, such as preloading of the digital content items planned for presentation on a monthly basis, bi-monthly basis, etc.

At step 220, the common clock reference is distributed to the DUs 120 and PEDs 130 from the content source 110 and/or the DU(s) 120 having the master clock. This step can be periodically repeated to ensure that the local clocks of the DUs 120 and PEDs 130 are maintained in synchronization.

At step 230, the PED 130 is associated with a local DU 120 (“local” can be considered to refer to the DU 120 that corresponds to the seat where the passenger carrying the PED 130 is sitting—either in an overhead DU servicing a group of passengers or an individual seatback unit) and/or the aircraft's on-board wireless network. The association of the PED 130 can be upon the initial communication from the PED 130 with the aircraft's wireless system (e.g., a request to join the network after the PED 130 “discovers” the wifi signal), a pairing of the PED 130 with the local DU 120, or an initialization of the application installed on PED 130, which causes the PED 130 to “sign in” to the system 100. The initialization of the application PED 130 within range of the DU 120 can also cause the PED 130 and DU 120 to pair with each other over a short-range wireless protocol (e.g. a Bluetooth pairing) if it is available on both devices.

The application causes the PED 130 to request the common clock reference (of the master clock or, if applicable, the playback clock) from the clock master (DU 120 or content source 110). Alternatively, the common clock reference can be sent by the clock master (DU 120 or content source 110) to the PED 130 when the passenger initiates playback of a desired item of digital content on either the DU 120 or the PED 130.

At step 240, the audio component of one or more digital content items is provided to the PED 130 such that a certain amount of the audio component is preloaded into the PED 130 prior to initiating the playback of the content. In preferred embodiments, the amount preloaded is sufficient to provide a buffer, such that network delays (e.g. packet delays, packet retries) do not cause an interruption or under-run of the audio playback relative to the video playback on the DU 120. After playback is initiated, the DU 120 can stream or otherwise subsequently transmit the remaining audio content data to PED 130 such that amount of buffered data stored within PED 130 is kept between a minimum and maximum buffer limit. This initial buffer amount can be provided by DU 120 after pairing with the PED 130.

In embodiments, the system 100 can be programmed to permit a PED 130 to be preloaded via the application, such that the user can pre-load (or the data be automatically preloaded) the buffered data from a different network via signing into the system. As such, the PED 130 can be preloaded with the buffer data before the passenger boards the flight. In these embodiments, the buffered data can be encrypted and the DU 120 can provide the PED 130 with the decryption keys upon pairing.

In embodiments, the buffered data can correspond solely to a selected item of digital content (i.e., a movie or TV show a priori selected by the user from an on-demand offering). In other embodiments, the buffered data can include a buffer of audio data from more than one (and up to all) available content items for selection, such that the audio content data will be ready for whatever digital content item the user selects for viewing.

At step 250, the content source 110 sends a command message to begin playback of a digital content item to all participating DUs 120 and PEDs 130. The command message contains a content identifier (identifying the digital content item to be played back), the playback state (play, pause, idle, etc.) and a presentation start time (relative to the shared common clock reference time of the master clock). The command message is relatively small, and low-bandwidth.

At step 260, the PED 130 and DU receives the command message and retrieves the digital content item corresponding to the content identifier in the command message from its memory, and begins playback of the digital content item. The initial media playback position (i.e. the playback offset relative to the start of the media) is set to the current local clock time minus the presentation time (from the command message). Each DU 120 and PED 130 also keeps track of the elapsed presentation time since the start.

Subsequent to start of playback, the clock master (content source 110 or DU 120) can transmit periodic content messages to PEDs 130 and DUs containing the present playback state, the content identifier and the current presentation time. As the message content is very small and has a low time sensitivity, it can be sent with relatively low frequency (a few times a second or less). These messages will consume a very small percentage of available bandwidth at any given time.

As each DU 120 and PED 130 receives a command message following the initial command message, it updates its local copy of the presentation start time. Each DU 120 and PED 130 calculates its presentation drift (which may be positive or negative) as equal to the current media position minus the local clock time minus the presentation start time. If the presentation drift is large, it indicates that the playback of the digital content item by that DU 120 or PED 130 is not in sync with the “theoretical” playback of the digital content items by the system as a whole (i.e., where the clock master (content source 110 or DU 120) indicates the playback “should be” in terms of time), and as such is likely out of sync with the actual playback of other DUs 120 and/or PEDs 130 within aircraft 101. The DU 120 or PED 130 then adjusts the playback speed of the media item (i.e., speeds up or slows down playback) such that the absolute value of the calculated presentation drift is minimized. The adjustments to the speed of the digital content item can be performed by one or more of duplicating samples/frames, dropping samples/frames, and adjusting the presentation rate.

In embodiments, if the difference between the current presentation time and the tracked audio playback time are greater than a threshold (for example, 100 milliseconds), the PED 130 causes the audio playback to “jump” to an audio playback time that matches the received current presentation time.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An in-flight entertainment system for the delivery of synchronized content, comprising:
a content source comprising a processor, a memory, a wireless communication interface, and a display, the content source programmed to:
transmit a common clock reference to a personal entertainment device (PED) and to a display unit DU, the common clock reference comprising an indication of a current time of a master clock;
receive a command to initiate playback of a digital content item, the digital content item comprising a video component and an audio component;
generate a command message, the command message comprising a content identifier associated with the digital content item, a playback state of the digital content item and a presentation start time of the digital content item;
transmit, via the wireless communication interface, the command message to the PED to cause the PED to initiate playback of a buffered portion of the audio component at the presentation start time;
transmit, via the wireless communication interface, the command message to the DU to cause the DU to initiate playback of locally stored video content; and
stream, via the wireless communication interface, the audio component to the PED.

2. The system of claim 1, further comprising the PED comprising a processor, a memory, a wireless communication interface, and an audio output interface, the PED programmed to:
obtain the buffered portion of the audio component;
receive the command message from the content source; and
initiate playback of the audio component via the audio output interface at the presentation start time.

3. The system of claim 2, further comprising the DU comprising a processor, a memory, a wireless communication interface, and an video output interface, the DU programmed to:
pre-store the video content;
receive the command message from the content source; and
initiate playback of the video component via the video display interface at the presentation start time.

4. The system of claim 3, wherein the content source is further programmed to:
periodically generate an updated command message, the updated command message comprising an updated content identifier, an updated playback state of the digital content item and a presentation time corresponding to the start time of the media item relative to the shared clock reference; and
transmit, via the wireless communication interface, the updated command message.

5. The system of claim 4, wherein the PED is further programmed to:
track a playback time of the audio component, corresponding to the time elapsed since the playback was initiated;
receive the updated command message from the content source;
compare the presentation run time to the playback time; and
if the presentation run time is different from the playback time, adjust the playback of the audio component based on the difference.

6. The system of claim 5, where the adjustment comprises at least one of speeding up playback and slowing down playback of the audio component.

7. The system of claim 1, wherein the wireless communication interface comprises a short-range wireless communication interface.

8. The system of claim 1, wherein the DU is further programmed to pre-cache the digital content item from a content source according to a pre-defined schedule.
